(19) United States
(12) Patent Application Publication
(10) Pub. No.: US 2006/0001885 A1
(43) Pub. Date: Jan. 5, 2006

(54) Method and device for quantitative determination of the optical quality of a transparent material

(76) Inventors: Albrecht Erich Hertzsch, Grosschwabhausen (DE); Knut Rainer Kroeger, Ilmenau (DE); Michael Selle, Kleinmoelsen (DE); Christain Lemke, Jena (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/098,613

(22) Filed: Apr. 5, 2005

(30) Foreign Application Priority Data
Apr. 5, 2004 (DE) 102004017237.4

(51) Int. Cl. G01N 21/47

(52) U.S. Cl. 356/446

(57) ABSTRACT

The present invention relates to a method and a device for quantitative determination of the optical quality of a transparent material. In the method, a light beam is incident on the sample made of the transparent material, in order to form a scattering volume in the sample, wherein light scattered in the scattering volume at a predefined scattering angle (Θs) is imaged on a light-sensitive element and wherein signals of the light-sensitive element are integrated or added up over at least a portion of the scattering volume in order to determine a measured value representing the optical quality of the transparent material of the sample. Signal contributions which do not originate from scattering of the incident light beam at the light entry or light exit surfaces of the sample are used exclusively to determine the measured variable.

### FIELD OF INVENTION

The present invention relates to a method and a device for quantitative determination of the optical quality of a transparent material. In particular, the present invention relates to a method and a device, using which, based on the principle of imaging scattered light measurement, scattered light parameters of an optically transparent sample are determined, which are used as A measure for the material quality characterization in regard to size and distribution of diffuse scattering centers in the transparent sample. An especially preferred aspect of the present invention relates to the characterization of optically transparent materials for EUV lithography (extreme ultraviolet lithography), for manufacturing optical elements, such as lenses or prisms, or for masks for microlithography.

### BACKGROUND OF INVENTION

In order to be able to specify the optical quality of transparent materials, it is important to determine the scattering behavior of the light as it passes through the material. Light scattering at volume inhomogeneities in optical elements (such as lenses and prisms) may significantly worsen the imaging properties of the overall optical system. Therefore, quantifying the light scattering behavior of an optical blank, which is used for manufacturing optical elements, is required by manufacturers of optical materials, in order to allow a “good-bad check” or a classification into fields of use having different optical requirements.

Until now, subjective classification of the scattering behavior of optical blanks into scattering classes was typically used. The scattering behavior of the sample was divided into scattering classes on the basis of visual observation. In this case, both the subjectively perceived scattering performance and the homogeneity of the scattering were combined into a quality parameter which was to characterize the optical quality of the sample. This parameter characterizes the scattering behavior only very imprecisely. In order to objectify this quality control, it is necessary to measure the scattered light. A typical scattered light measurement system for evaluating the transmission properties of optical elements is a TS measuring apparatus (ISO/DIS13696). The sample is illuminated perpendicularly by a light beam and the light scattered in the transmission direction is integrally absorbed and evaluated using an Ulbricht sphere (cf. ASTM F 1048-87) or a Coblentz sphere (cf. Gliech, S., Steinert, J., Duparre, A.: Light scattering measurements of optical thin-film components at 157 and 193 nm, App. Optics, Vol. 41, No. 16, 2002). The TS (total scattering) value thus determined describes the global scattering loss of the sample precisely. However, the scattering behavior of the sample is observed in its entirety. Not only volume scattering within the sample contributes to the scattering behavior, but rather also boundary layer scattering at the entry and exit surfaces of the sample.

When characterizing optical blanks, it is to be considered that they typically have only a simple surface polish, so that the scattering at the boundary layers is more intensive by several orders of magnitude than the scattering at the volume inhomogeneities. The measured TS value therefore predominantly characterizes the scattered light behavior of the boundary layers.

U.S. 2001/0040678A1 discloses a device and a method for detecting inclusions and/or scattering centers in a plate made of an optically transparent material. A light beam is perpendicularly incident on an entry surface of the plate, passes through the plate, and is partially scattered in the forward direction at the same time. A light trap is provided behind the plate, which prevents the light beam from being incident on a photodetector that is positioned behind the light trap. A lens positioned behind the light trap images the light which is scattered in the forward direction in a conical spatial angle range on the photodetector. The scattering angle range is comparatively large and predefined by the numerical aperture of the lens. Light which is scattered at the light entry or light exit surfaces of the plate may not be separated from light which is scattered in the beam volume within the plate. The light entry and light exit surfaces of the plate must therefore be finely polished, which is complex. Even if the light entry and light exit surfaces of the plate are finely polished, scattering at the boundary layers may not be separated from scattering at the volume inhomogeneities if the plate to be checked is too thin.

GB 2379977 A discloses a smoke alarm, in which light scattered in a volume in the forward direction is detected using a construction which is comparable to the construction described in U.S. 2001/0040678A1. Instead of a lens which is positioned behind the light trap, the use of ellipsoidal hollow mirrors is disclosed in order to enlarge the detectable scattering angle range.

U.S. Pat. No. 5,471,298 discloses a method and a device for determining the size of defects or scattering centers in a crystal. A light beam is perpendicularly incident on the sample and forms an oblong scattering volume within the sample. Light which is scattered at defects or scattering centers within the scattering volume at 90° in relation to the optical axis of the incident light beam is imaged on a light-sensitive element. The imaging of the scattered light on the light-sensitive element is selected so that defects or scattering centers may be detected with their location resolved and resolved in regard to their size. In order to detect the defects or scattering centers in the entire oblong scattering volume, the light-sensitive element and an assigned imaging optic must be moved along the entire length of the scattering volume, i.e., over the entire length of the sample, and multiple image recordings along the entire length of the scattering volume or of the sample must be analyzed, which is time-consuming and tiresome.

WO 01/73408A1 discloses a device and a method for detecting defects or scattering centers in an optically transparent sample. Light is perpendicularly incident on the surface of the sample in order to form an oblong scattering volume in the sample. The light scattered at defects or scattering centers within the scattering volume is detected at 90° in relation to the optical axis of the incident light beam. A one-dimensional matrix of light-sensitive elements, which is aligned along an edge of the sample, is used for detection. The imaging of the scattered light on the matrix of light-sensitive elements is selected so that the entire scattering volume in the sample, including the light entry surface and the light exit surface, is imaged on the one-dimensional matrix of light-sensitive elements. Therefore, all defects or scattering centers in the beam volume may be detected with their locations resolved using one recording. Separation of the scattering at the light entry and light exit surfaces of the sample from the scattering at volume inhomogeneities is not provided. Individual image locations and/or scattering centers in the oblong scattering volume may be detected with high precision and their locations resolved, in order to sort out individual faulty volumes in the sample, but simple quantitative characterization of the optical quality of the sample is nonetheless not possible.

DE 102 10 209 A1 discloses a method and device for inspecting a sample using scattered light, wherein light is incident perpendicularly on a polished entrance surface, forms an oblong scattering volume in the material of the sample and exits the sample via a polished exit surface. An optical inspection analysis unit acquires the scattered light from the oblong scattering volume via the entrance or exit surface under a predefined viewing angle. By adjusting the inspection optics the inspection region of the oblong scattering volume can be adjusted such that scattering contributions from the entrance or exit surface do not affect the measurement result. A detector measures the imaged scattered light contributions using an integration process for integrating all signal contributions and thus yields a quantifiable parameter for characterizing the optical quality of a transparent sample. However, effects due to multiple scattering in the inspection optical path towards the inspection analysis unit cannot be suppressed and adulterate the measurement result. This is disadvantageous if the polishing of the entrance and exit surface is not of good quality or if the measurement is performed in border areas of the sample, where multiple scattering of the interfaces of the sample that are parallel to the direction of light propagation give rise to non-negligible scattering contributions in the inspection optical path.

### SUMMARY OF INVENTION

It is an object of the present invention to provide a method and a device, using which the optical quality of the transparent material of a sample may be characterized quantitatively in a simple and cost-effective way.

According to the present invention, there is provided a method for quantitative determination of the optical quality of a transparent material of a sample, in which method a light beam is incident on the sample of the transparent material in order to form a scattering volume within the sample, and a light scattered in the scattering volume at a predefined scattering angle is imaged on a light-sensitive element, wherein signals of the light-sensitive element are integrated or added up over at least a portion of the scattering volume in order to determine a measured value representing the optical quality of the transparent material of the sample.

According to the present invention all defects or scattering centers in the scattering volume within the sample are detected simultaneously by the light-sensitive element. By integrating or adding up the signals of the light-sensitive element, the intensity of the scattered light is integrated or added up, so that a measured value may be determined, which specifies the optical quality of the transparent material in a unique way. Such a uniquely determinable measured value is suitable as the manufacturer specification of optically transparent materials. Furthermore, it is advantageous that according to the present invention a complex determination of individual defects or scattering centers in the scattering volume which is resolved by location may be dispensed with in principle. A complex statistical analysis of scattering centers or defects detected in the scattering volume with their locations resolved, using frequency distributions and the like, may also be dispensed with.

According to a preferred aspect of the present invention, the image field of the light-sensitive element is trimmed in such a way that no scattered light which originates from scattering at the light entry and light exit surfaces of the sample is used for determining the measured variable. Such image plane trimming may be implemented through suitable geometry of the beam path of the scattered light, through suitable positioning of the light-sensitive element in relation to the sample, or using a suitable aperture and/or a suitable beam shaping means in the beam path of the scattered light.

According to a further embodiment of the present invention, such image plane trimming is implemented electronically using suitable image analysis software, which suppresses signals originating from light scattering at the light entry or light exit surfaces of the sample.

According to a preferred aspect of the present invention, the light-sensitive element is a one-dimensional or two-dimensional matrix of light-sensitive elements, such as a one-dimensional or two-dimensional CCD matrix. According to the present invention, the brightness values of the pixels which correspond to the scattering volume are added up or integrated in order to provide the measured value according to the present invention. Simultaneously, however, detection of defects or scattering centers in the scattering volume with their locations resolved is still possible.

According to a further aspect of the present invention the scattered light is imaged such onto the one-dimensional or two-dimensional array of light-sensitive elements that the scattering volume lies in an object plane of the imaging system or of the imaging optics. Thus, the selectively excited scattering volume and the associated stray field, which is in particular due to multiple scattering processes or due to single scattering processes outside of the selectively excited scattering volume, can be imaged with spatial resolution. Due to the characteristics of the imaging system or imaging optics, a separation between signal contributions, which shall contribute to the measured value and stem from single scattering processes, and stray contributions, which are in particular the result of multiple scattering processes, becomes possible, because the image of signal contributions outside of the selectively excited scattering volume is imaged on the light-sensitive elements in a ‘blurred’ manner. This effect of blurred imaging can be discriminated by means of well-known image processing algorithms. Furthermore, the optical background noise, which is the result of multiple scattering processes, can be acquired automatically in characteristic image segments and can be used for correcting the measured value and for determining a signal-to-noise-ratio. In particular, for performing this correction, it can be envisaged that signal contributions, which do not result from multiple scattering processes, can account for the determination of the measured value.

In summary, a light beam is therefore incident on one of the polished interfaces of the sample, the light beam penetrating the material and exiting at the second polished interface, which is diametrically opposite to the first polished interface and parallel thereto. The scattering volume implemented in the illuminated material volume is imaged with the aid of a camera at a fixed scattering angle Θs to the surface perpendicular of the exit surface. This scattering angle is preferably selected so that it corresponds to a typical aperture angle for the later optical application. The optical imaging system is dimensioned in such a way that the delimitation of the image plane, as is predefined by the dimensions of the CCD matrix and/or the aperture, trims the object plane to be measured. Therefore it is possible to suppress the scattered light component of the first and second boundary layers of the sample, i.e., the light entry and light exit surfaces. The entire scattering volume is detected by tracking the camera, the sectional width change of the imaging in increasing material depth being compensated for by a two-dimensional camera guide. The scattering volume, which is therefore registered in multiple images, may have its homogeneity inspected with high resolution. Furthermore, the overall scattered power of the scattering volume at a fixed scattering angle Θs may be measured and characterize the scattered light behavior of the sample as a quantifiable variable. In order to be able to specify a standardized value for the quantitative description of the scattering behavior of the sample, the BSDF (bidirectional scatter distribution function) is used as the scattered light parameter. For perpendicularly incident light, it is a function of the scattering angle Θs and the scattered light azimuth angle σs and describes the ratio of measured scattered power Ps in a spatial angle element dΩs predefined by the measurement aperture in relation to the incident power Pi and, according to Stover (cf. Stover J. C.; Optical scattering—measurement and analysis; McGraw-Hill, Inc. 1990), is defined by:
BSDF=(Ps/Ωs)/(Pi cos Θs).

The cosine factor projects the illuminated scattering volume in the direction of the scattering angle Θs and thus allows a direct comparison to scattered light measurements of surfaces. The unit of the BSDF is 1/steradian. For the characterization of the scattered light behavior of transparent testing bodies, according to the present invention the power of the scattered light is detected at a fixed scattering angle Θs, so that the BSDF value for Θs=constant is specified as a quantifiable scattered light parameter. Objective evaluation of the scattering behavior of transparent samples is possible with the aid of this parameter.

### BRIEF DESCRIPTION OF DRAWINGS

In the following, the present invention will be described on the basis of preferred exemplary embodiments and with reference to the attached drawings, from which further features, advantages, and objects to be achieved will result and in which:

FIG. 1 illustrates a schematic view of a device according to the present invention for quantitative analysis of the scattering behavior of a transparent sample, incident light on the sample being scattered and detected at a fixed scattering angle; and

FIG. 2 illustrates a schematic flowchart of a method according to the present invention for quantitative analysis of the scattering behavior of a transparent sample.

### DETAILED DESCRIPTION OF ECEMPLARY EMBODIMENTS

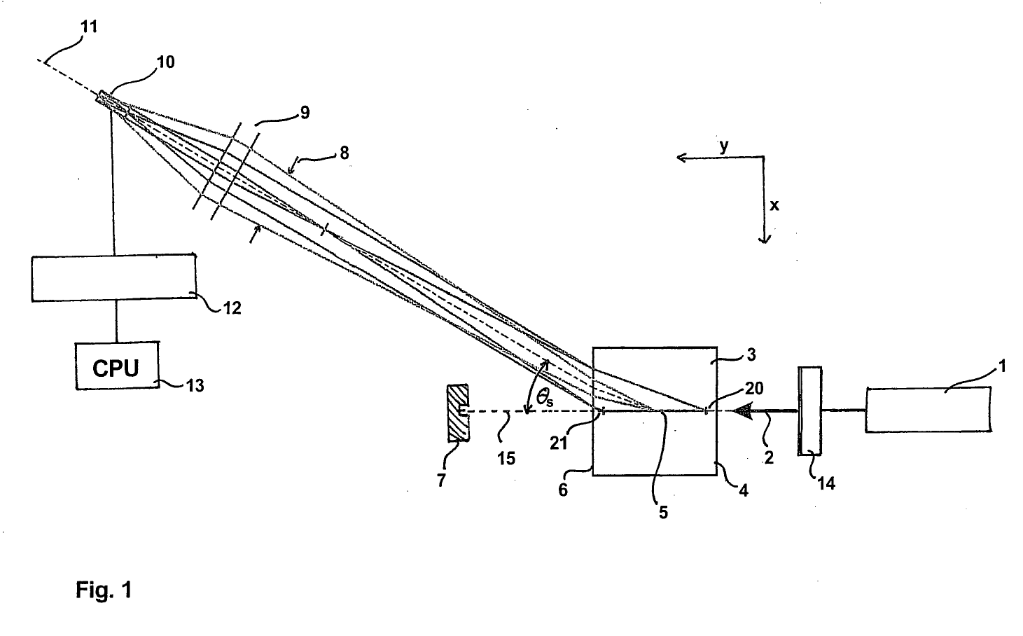

As shown in FIG. 1, a laser 1, such as a He—Ne laser at a wavelength of 650 nm, emits a light beam 2, which is perpendicularly incident on the sample 3. The sample 3 has a polished light entry surface 4 and a polished light exit surface 6, positioned at a distance and parallel thereto. The optical axis defined by the incident light beam 2 is perpendicular to the light entry and light exit surfaces 4, 6. After exiting the sample 3, the exiting light beam 15 is imaged on a light trap 7, which prevents any light not scattered in the sample from being imaged on the light-sensitive element 10. In the sample 3, the light beam 2 implements an oblong scattering volume 5, whose profile corresponds to the profile of the entering laser beam 2 and is predefined by the imaging geometry used. As may be inferred from FIG. 1, the cross-section of the entering light beam 2 is significantly smaller than a dimension of the sample 3 perpendicular to the optical axis fixed by the light beam 2.

Light which is scattered on inhomogeneities or diffuse scattering centers, such as defects, scattering centers, volume inhomogeneities, and the like, in the scattering volume 5 in the spatial direction Θs, is imaged using an aperture 8 and a lens or an objective 9 on a CCD camera 10, which has a one-dimensional or two-dimensional matrix of light-sensitive elements, one edge of which is aligned parallel to a plane defined by the optical axis of the incident light beam 2 and the optical axis 11 of the scattered light. The light-sensitive elements of the CCD camera 10 are read out, processed further, and analyzed by an image analysis unit 12 and a CPU 13, as described in the following.

As shown in FIG. 1, the aperture 8 determines a solid angle element which is imaged on the CCD camera 10. The numerical aperture of the aperture 8 may be selected so that suitable portions of the scattering volume 5 are imaged on the CCD camera, as described in the following.

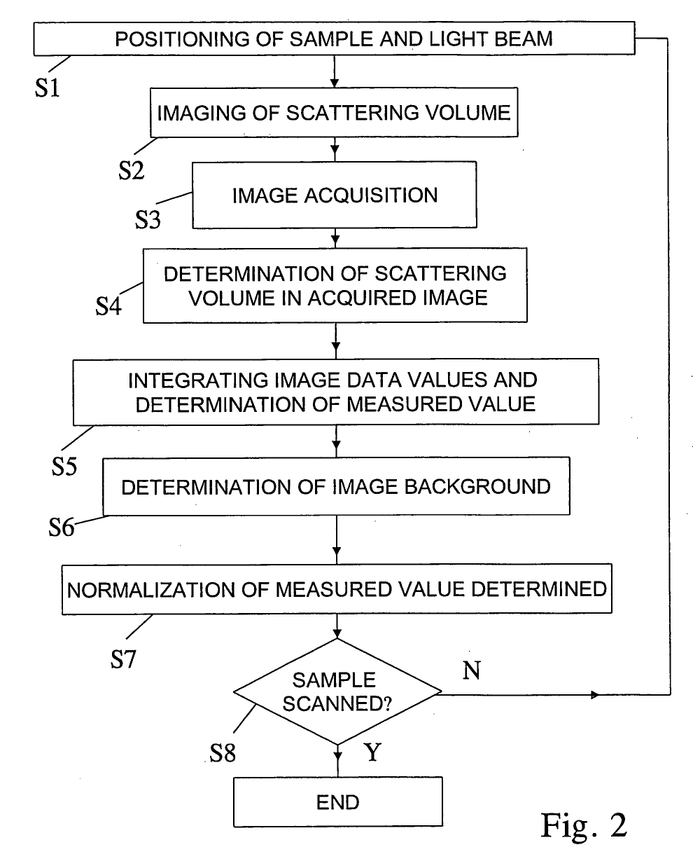

As shown in FIG. 1, a front end 20 of the scattering volume 5, which is used to determine the measured value, is defined at a distance to and downstream from the light entry surface 4 of the sample 3, and a rear end 21 of the scattering volume 5, which is used to determine the measured value, is defined upstream from the light exit surface 6 of the sample 3. The distance of the front end 20 or the rear end 21 to the light entry surface 4 or the light exit surface 6, respectively, of the sample 3 is selected so that any light which originates from scattering of the incident light beam 2 on the light entry surface 4 or on the light exit surface 6 is not used for determining the measured variable. This delimitation of the image plane may be provided in principle exclusively with the aid of the geometry of the beam path of the scattered light and the positional relationship of the CCD camera 10 in relation to the sample 3, but may also, however, be performed in principle through suitable analysis of the image data values read out from the CCD camera 10 using the image analysis unit 12 and/or the CPU 13, as described in the following on the basis of FIG. 2.

In order to be able to measure any arbitrary volume portion of the sample 3, the sample 3 is held on a sample support (not shown) and may be displaced arbitrarily in the xz plane. In order to allow images of the scattering volume 5 in different material depths, the CCD camera 10, the objective or the lens 9 and the aperture 8 are supported jointly and may be pivoted jointly in the xy plane. As shown in FIG. 1, light which is scattered at an acute angle Θs in the forward direction is imaged on the CCD camera 10. According to the present invention, this scattering angle Θs is preferably matched to an aperture angle of the optical element to be manufactured from the material of the sample 3 and especially preferably corresponds entirely thereto. If, for example, an optical lens having a predefined numerical aperture is manufactured from the material of the sample 3, the scattering angle Θs is preferably set to the value of the aperture angle corresponding to the numeric aperture or to values which are smaller than the aperture angle thus fixed. The scattering angle Θs is preferably less than approximately 45°, more preferably less than approximately 30°.

As shown in FIG. 1, the entire light scattered in the scattering volume 5 at the scattering angle Θs exits out of the light exit surface 6 of the sample 3. This is not absolutely necessary, however, rather light scattered at the spatial angle Θs may additionally or exclusively exit out of the lateral surface of the sample 3 on the right-hand side, as viewed in the beam direction of the incident light beam 2, if, for example, regions near the lateral surface on the right-hand side of the sample 3 are to be measured. The geometry of the beam path of the scattered light and the positional relationship of the CCD camera 10 in relation to the sample 3 are always selected in this case so that only predefined regions or portions of the scattering volume 5, as described in the following, are imaged on the CCD camera 10. In this case, the light refraction at the boundary layer between the sample 3 and the air surrounding the sample 3 is to be considered for the imaging, as may be inferred from the illustration of the beam path in FIG. 1.

To determine the power of the incident light beam 2, a beam splitter 14 may be provided in front of the light entry surface 4 of the sample 3, which images a part of the incident light beam on a photodetector (not shown), whose output signal may be read in by the CPU 13 and processed further.

In the following, an exemplary method according to the present invention for quantitative determination of the optical quality of a transparent material of a sample is described with reference to FIG. 2.

Firstly, in step S1, the sample 3 and the light beam 2 are positioned suitably in relation to one another, as shown in FIG. 1. Using the relationship thus fixed between sample 3 and incident light beam 2, an oblong scattering volume 5 is implemented in the sample 3, which is located in the xz plane at a predefined position.

The geometry of the beam path of the scattered light and the positional relationship of the CCD camera 10, the lens or the objective 9, and the aperture 8 are then selected so that light which is scattered in the scattering volume 5 at a predefined solid angle is imaged on the CCD camera 10. In principle, the entire scattering volume 5 may be imaged in this case. Most preferably, however, the parameters of the imaging are selected in such a way that only the scattering volume between the front and the rear end regions 20, 21 as shown in FIG. 1 is imaged on the CCD camera 10, i.e., the image plane is trimmed suitably on the basis of the geometry of the beam path of the scattered light and the positional relationship of the CCD camera 10 in relation to the sample 3. According to a further embodiment, subportions of the scattering volume 5 between the front and the rear end regions 20, 21 may also be imaged on the CCD camera 10, the entire length of the scattering volume 5 between the front and the rear end regions 20, 21 finally being scanned by pivoting the unit formed by the aperture 8, the objective or the lens 9, and the CCD camera 10 step-by-step around the center of the sample 3. The images of the scattering volume 5 thus imaged step-by-step are then assembled into an image of the scattering volume 5 in the image analysis unit 12 and/or the CPU 13 through summation or integration, as described in the following.

The parameters of the imaging of the scattering volume 5 on the CCD camera 10 for suitable image plane trimming may be fixed one time beforehand if the geometry of the testing device is known, particularly if the dimensions of the sample 3, the scattering angle Θs, the distance of the CCD camera 10 to the sample 3, and the focal width of the objective or the lens 9 are known.

As is obvious without anything further to those skilled in the art, corresponding image plane trimming may also be performed electronically on the image data values read out from the CCD camera 10. For this purpose, image analysis software may automatically identify comparatively bright pixels which originate from the comparatively strong scattering of the light beam 2 at the light entry surface 4 or the light exit surface 6, together with the number of pixels between the front and rear bright regions thus determined on the chip of the CCD camera 10. This number of pixels represents a measure of the projection of the length of the scattering volume 5 on the optical axis 11 of the scattered light. The image analysis software then calculates a number value, knowing the total length of the sample 3 along the direction of incidence of the light beam 2, which corresponds to the number of pixels for the distance between the light entry surface 4 of the sample 3 and the front end 20 of the scattering volume 5 or for the distance between the light exit surface 6 and the rear end 21 of the scattering volume 5. The image analysis software then cuts off the number of pixels thus calculated on the basis of the previously determined bright portions, which correspond to the light scattering on the light entry surface 4 or the light exit surface 6, and only uses the remaining pixels, which correspond to the untrimmed image plane, for further image analysis.

In this way, an image of the sample 3 is detected (step S3) and a scattering volume is determined in the detected image (step S4). Of course, multiple images recorded one after another for the same position of the sample 3 may be averaged for further noise suppression.

According to the present invention, the front or rear end 20, 21 of the scattering volume 5 is thus at a sufficient distance to the light entry surface 4 or the light exit surface 6, respectively, of the sample 3, so that it is always ensured that no scattered light which originates from light scattering at the light entry surface 4 or the light exit surface 6 is used for the characterization of the optical quality of the sample 3.

Subsequently, in step S5, the image data values detected in the scattering volume thus determined are added up or integrated. This integration or summation is performed, in the simplest case of a one-dimensional CCD line, in one direction between light-sensitive elements which correspond to the front or rear end 20, 21 of the scattering volume 5. For the case of a two-dimensional CCD matrix, the edges of the scattering volume 5 in the xz plane may also be determined in step S4. Of course, these edges may also be fixed beforehand. For the case of a CCD camera 10 having a two-dimensional CCD chip, the image data values are integrated or added up in step S5 over all lines which correspond to the scattering volume 5. This integration or summation may be executed rapidly using the CPU 13, so that according to the present invention a measured value which uniquely characterizes the optical quality of the sample 3 may be determined very rapidly.

In order to eliminate interfering influences due to noise or a non-vanishing image background, a further step S6 may be provided, wherein portions of an image background are determined for which a background value is determined, which is subtracted from the measured value determined in step S5. In order for the measured value determined in step S5 to be independent from the intensity of the incident light beam 2, the measured value determined in step S7 may also be normalized to the intensity of the incident light beam 2. For this purpose, the beam splitter 14 shown in FIG. 1 may be used, as described above. In order for the measured value determined in step S5 to be independent of the actual length of the scattering volume 5 imaged on the CCD camera 10, the measured value determined in step S7 may also be normalized to the actual length of the scattering volume 5 imaged on the CCD camera 10.

The measured value thus determined corresponds to the value BSDF (bidirectional scatter distribution function), which was described above and may be specified as the uniquely quantifiable scattered light parameter for a predefined scattering angle Θs. With the aid of this parameter, an objective evaluation of the scattering behavior of a transparent sample is possible according to the present invention.

Of course, the entire surface of the sample 3 may be scanned in the way described above, which is checked in the query step S8 shown in FIG. 2. In this way, a two-dimensional map for the optical quality of the sample 3 in the xz plane may be determined.

As may be inferred easily from the above description, the image of the scattering volume is detected with locations resolved (spatially resolved) with the aid of a one-dimensional or two-dimensional CCD camera in step S3. Therefore, scattering centers and the like in the scattering volume 5 may also be registered and inspected at high resolution according to the present invention.

Experiments of the inventor have shown that according to the present invention the optical quality of a sample may be determined very rapidly and reproducibly. The number value thus determined is outstandingly suitable for specification, for example, as a manufacture specification.

Although, according to the above description, the measured value is determined for a predefined scattering angle Θs, the present invention is not restricted thereto. Rather, measured variables may be determined and specified in the way described above even for multiple different scattering angles Θs, which is advantageous, for example, if the transparent material to be tested is usable for multiple different optical applications.

As may be inferred from the above description, a further aspect of the present invention is directed to software, in order to control the CPU 13, the image analysis unit 12, the CCD camera 10, a pivot unit (not shown) for pivoting a unit formed by the aperture 8, the objective or the lens 9, and the CCD camera 10 around the center of the sample 3 or for adjusting the sample support to execute the method described above in a suitable way. Such software may be stored on a suitable data carrier, such as a CD-ROM, a magnetic or optical data carrier, or a memory component, and may be machine or computer readable.

For eliminating signal contributions due to a non-vanishing image background or noise, according to another embodiment of the present invention the following additional steps can be performed: Firstly, the characteristics of the imaging system or imaging optics are chosen in order to ensure that the scattering volume 5 lies in the object plane of the lens 9 and is imaged sharply onto the CCD-matrix of the camera 10. As it can be assumed that the geometrical dimensions of the selectively excited scattering volume 5 in the image plane are known for the fixed imaging scale, localizing the desired scattering volume in the acquired image of the CCD-camera 10 is conducted automatically. By convolution of the image information with a mask, whose dimensions correspond to those of the image portion, a homogeneous image portion having a maximum intensity is determined, which represents the measurement information of the selectively excited scattering volume in the image. A subsequent pattern recognition checks, whether the received image segment is affected by extensive scattering effects (e.g. homogenous scattering circles or needle-shaped beams), which are the result of scattering at single defects that lie outside of the object plane and thus outside of the selectively excited scattering volume and are imaged by the imaging system in a blurred manner. Depending on their intensity, these image defects are filtered by using filter algorithms or are excluded from the measurement information by displacing a mask into another image segment of the volume scattering which is affected less.

Thus, in this method a selectively excited scattering volume and the associated stray field are imaged with spatial resolution. Due to the characteristics of the imaging system or imaging optics, a separation between measured values and stray contributions is possible so that single scattering centers that do not lie in the object plane are identified as image defects due to their inferior imaging quality and are filtered by using image processing algorithms and so that the optical background noise, which is due to multiple scattering processes, is acquired automatically in characteristic image segments and is used for signal correction and for determining a signal-to-noise-ratio.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

The entire disclosure of all applications, patents and publications, cited herein and of corresponding German application No. 102004017237.4, filed Apr. 5, 2004 and is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

What is claimed is:

1. A method for quantitative determination of the optical quality of a transparent material of a sample, in which method a light beam is incident on the sample made of the transparent material, in order to form a scattering volume in the sample, and light scattered in the scattering volume at a predefined scattering angle (Θs) is imaged on a light-sensitive element, wherein signals of the light-sensitive element are integrated or added up over at least a portion of the scattering volume in order to establish a measured value representing the optical quality of the transparent material of the sample.

2. The method according to claim 1,
wherein a front or rear end of the scattering volume, which is used for determining the measured variable, is at a distance to a light entry surface or a light exit surface, respectively, of the sample, so that no scattered light which originates from light scattering at the light entry or light exit surfaces of the sample is used to determine the measured variable.

3. The method according to claim 2,
wherein the geometry of the beam path of the scattered light is designed in such a way or an analysis of the signals of the light-sensitive element is performed in such a way that no scattered light which originates from light scattering at the light entry and light exit surfaces of the sample is used to determine the measured variable.

4. The method according to claim 1,
wherein the light is scattered in a forward direction, preferably at an angle of less than approximately 45°, more preferably at an angle of less than approximately 30°, in relation to an optical axis of the light beam incident on the sample.

5. The method according to claim 1,
wherein the scattered light is imaged on a one-dimensional or two-dimensional matrix of light-sensitive elements, preferably on a CCD matrix, and is detected with spatial resolution, wherein pixel values which correspond to the scattering volume or a portion thereof are integrated or added up to determine the measured variable.

6. The method according to claim 5,
wherein, in addition, an image background of a region in the sample, through which the incident light beam does not pass, is determined, and wherein intensity or pixel values of the image background are used in a normalization of the measured value determined, a length of the image background in the direction of the incident light beam preferably corresponding to the length of the scattering volume in the sample.

7. The method according to claim 6,
wherein the scattered light is imaged onto the one-dimensional or two-dimensional array of light-sensitive elements such that the scattering volume lies in an object plane of the imaging system or imaging optics, and wherein,
before integrating or summing up the pixel values, an image processing algorithm is applied to the pixel values so that signal contributions, which are caused by scattering outside of the image plane, are filtered and are not used for determining the measured value.

8. The method according to claim 7, wherein an optical background noise, which is due to multiple scattering processes, is acquired in characteristic image segments and is used for correcting the measured value and for determining a signal-to-noise-ratio.

9. The method according to claim 1,
wherein the measured value determined is also normalized to a power Pi of the incident light beam, the measured value determined (BSDF) being given by:
BSDF=(Ps/Ωs)/(Pi cos Θs),
Ps being a power of light which is scattered at the scattering angle Θs in the solid angle element dΩs.

10. The method according to claim 1,
wherein the sample comprises a solid, optically transparent material.

11. The method according to claim 10,
wherein the material of the sample is CaF₂.

12. A device for quantitative determination of the optical quality of a transparent material of a sample having:
a light source, preferably a laser light source, to emit a light beam which is incident on the sample made of transparent material to form a scattering volume in the sample;
a light-sensitive element for detecting light which is scattered at least in a portion of the scattering volume at a predefined scattering angle (Θs) onto the light-sensitive element; and
an image analysis unit for integrating or adding up signals of the light-sensitive element over at least a portion of the scattering volume, in order to determine a measured value representing the optical quality of the transparent material of the sample.

13. The device according to claim 12,
wherein the image analysis unit or the geometry of the beam path of the scattered light is designed in such a way that no scattered light which originates from light scattering at the light entry and light exit surfaces of the sample is used to determine the measured variable.

14. The device according to claim 12,
wherein the image analysis unit or the geometry of the beam path of the scattered light is designed in such a way that a front or rear end of the scattering volume, which is used to determine the measured variable, is at a distance to a light entry surface or a light exit surface, respectively, of the sample, so that no scattered light which originates from light scattering at the light entry and light exit surfaces of the sample is used to determine the measured variable.

15. The device according to claim 12,
wherein the light-sensitive element is positioned in such a way that the light is scattered in a forward direction, preferably an angle of less than approximately 45°, more preferably at an angle of less than approximately 30°, in relation to an optical axis of the light beam incident on the sample.

16. The device according to claim 12,
wherein the light-sensitive element comprises a one-dimensional or two-dimensional matrix of light-sensitive elements, preferably a CCD matrix, the image analysis unit being designed in order to read out pixel values of the matrix which correspond to the scattering volume or a portion thereof and integrate or add them up to determine the measured variable.

17. The device according to claim 16,
wherein the image analysis unit is also designed to determine an image background of a region in the sample, through which the incident light beam does not pass, and to use intensity or pixel values of the image background in a normalization of the measured value determined, a length of the image background in the direction of the incident light beam preferably corresponding to the length of the beam volume in the sample.

18. The device according to claim 17,
wherein the scattered light is imaged onto the one-dimensional or two-dimensional array of light-sensitive elements such that the scattering volume lies in an object plane of the imaging system or imaging optics, and wherein
the image analysis unit is configured such that, before integrating or summing up the pixel values, an image processing algorithm is applied to the pixel values so that signal contributions, which are caused by scattering outside of the image plane, are filtered and are not used for determining the measured value.

19. The device according to claim 18, wherein the image analysis unit is further configured such that an optical background noise, which is due to multiple scattering processes, is acquired in characteristic image segments and is used for correcting the measured value and for determining a signal-to-noise-ratio.

20. The device according to claim 12,
wherein the image analysis unit is also designed to normalize the measured value determined to a power Pi of the incident light beam, the measured value (BSDF) determined being given by:
BSDF=(Ps/Ωs)/(Pi cos Θs),
Ps being a power of light which is scattered at the scattering angle Θs in the spatial angle element dΩs.

21. The device according to claim 12, also including a sample supporting device to alter a position of the sample in a plane perpendicular to an optical axis of the incident light beam, so that the optical quality may be determined by complete scanning of a light entry surface of the sample.

22. The device according to claim 21,
wherein the material of the sample is CaF₂.
